(19) United States
(12) Patent Application Publication
(10) Pub. No.: US 2024/0235445 A9
(43) Pub. Date: Jul. 11, 2024

(54) METHOD FOR SELECTING A CHOPPING FREQUENCY OF AN INVERTER CONTROLLING AN ELECTRIC MACHINE, AND CORRESPONDING DEVICE

(71) Applicant: NIDEC PSA EMOTORS, CARRIERES SOUS POISSY (FR)

(72) Inventors: Gang YANG, COURBEVOIE (FR); Radu FRATILA, ANTONY (FR)

(21) Appl. No.: 18/546,558

(22) PCT Filed: Mar. 30, 2022
(86) PCT No.: PCT/FR2022/050590

§ 371 Date: Aug. 15, 2023

(30) Foreign Application Priority Data
Apr. 2, 2021 (FR) 2103440

(51) Int. Cl. B60W 10/08; B60W 10/26; H02P 21/22; H02P 23/14; H02P 27/04

(52) U.S. Cl. CPC B60W 10/08; B60W 10/26; H02P 21/22; H02P 23/14; H02P 27/045

(57) ABSTRACT

The invention relates to a method for selecting a chopping frequency for application thereof to an inverter controlling a rotating electric machine, wherein the chopping frequency is chosen from among multiple predetermined frequencies depending on the position, in a map, of a current operating point of the assembly formed by the electric machine and the inverter, said map having at least the rotational speed (N) of the electric machine or the frequency (Fe) of the electric current applied thereto as parameter. In at least part of the map, the chopping frequency is furthermore chosen based on a parameter representative of a thermal condition of the electronic switches contained in the inverter. The invention furthermore relates to a method for controlling a corresponding inverter, and to a device implementing this method. The invention is preferably applied to an electric motor vehicle.

### CROSS-REFERENCE TO RELATED APPLICATIONS

This application is the US National Stage under 35 USC § 371 of International Application No. PCT/FR2022/050590, filed Mar. 30, 2022, which claims the priority of French application 2103440 filed on Apr. 2, 2021, the content (text, drawings and claims) of both said applications being incorporated by reference herein.

### BACKGROUND

The devices and methods described herein relate to the operation of an inverter used to control an electric machine, in particular a rotating electric machine. The described methods and devices are preferentially applied to the operation of an inverter controlling an electric traction machine of an electric motor vehicle.

The inverter is an apparatus making it possible to generate an alternating current from a direct current coming from an electrical source such as a battery.

The inverters include a power stage including, for example, power modules, and more generally the power electronics of the inverter. The power stage includes a set of electronic switches.

Several electronic switch technologies can be used in an inverter used in an electric traction system of a vehicle, including:
Insulated Gate Bipolar Transistors (IGBTs), and
Metal Oxide Semiconductor Field-Effect Transistors (MOSFETs), in particular silicon carbide (SiC) power transistors.

By means of a set of switches appropriately controlled (generally pulse width modulation), the inverter modulates the source in order to obtain an alternating current of the desired frequency.

The inverter thus operates at a given chopping frequency (also referred to as switching frequency).

Typically, the switches of the inverter cause switching power losses when they pass from the open state to the closed state and vice versa, and losses in conduction. For a given motor speed and torque of the electric machine, the conduction and switching losses in the inverter are proportional to the chopping frequency.

A suitable choice of the modulation frequency makes it possible to improve the power efficiency of the assembly including the inverter and the electric machine that it controls. In this context, document US20130169206 proposes applying different chopping frequencies to an inverter controlling a rotating electric machine according to the current operating point (that is to say at the considered instant) in a map having as parameters the rotational speed of the electric machine (also referred to as motor speed) and the torque setpoint that said electric machine must provide. The map includes four parts in the nominal operation area of the electric machine, that is to say in the area of speed and torque for which the machine has been sized so as to operate in a smooth and reliable manner.

Likewise, document CN110138284 discloses the application of a strategy of varying the chopping frequency, between different predefined chopping frequencies, according to the speed of the electric machine and the current intensity or torque setpoint. Indeed, there is a bijective relationship between the torque setpoint and the electric current (that is to say, the effective current intensity) to be applied. According to this document, the chopping frequency increases based on the speed of the electric machine and can adopt six increasing values each adapted to a range of motor speed values.

Such strategies make it possible to improve the power efficiency of the assembly formed by the inverter and the electric machine (that is to say, the ratio between the power delivered and the losses), but the performance and the comfort in terms of noise, vibration and harshness (commonly referred to by the acronym “NVH”) are degraded. In the context of an electric vehicle, each switch from one chopping frequency to another is perceptible by the user, typically by the driver and/or the occupants of the vehicle. From a sound and vibratory point of view, the harmonics generated at the different chopping frequencies make it difficult to manage the waves and resonances with other pieces of equipment present on the high-voltage electrical network. In addition, frequent changes from one chopping frequency to another lead to complexity in the operation of the inverter, insofar as many operating parameters must be modified or initialized with every change of chopping frequency.

Nevertheless, the use of a variable chopping frequency is advantageous not only to improve the power efficiency, but also to avoid overheating of the inverter, in particular of its power stage, and in particular of the switches of the inverter, especially at low motor speed and/or high torque of the electric machine. Indeed, in a situation of low motor speed under a high torque setpoint driving a high-intensity electric current, the switching losses are significant, while a low chopping frequency would be sufficient to obtain sufficient responsiveness in the control of the electric machine. Similarly, limiting the risk of overheating of the inverter also makes it possible to accurately size the inverter, which limits the cost and mass thereof.

### SUMMARY

The present description therefore aims to propose a solution making it possible to apply a variable chopping frequency strategy to an inverter, while limiting the disadvantages and risks in terms of NVH of such a strategy.

The present description thus relates to a method for selecting a chopping frequency for application thereof to an inverter controlling a rotating electric machine. According to this method, the chopping frequency is chosen from among multiple predetermined frequencies depending on the position, in a map, of a current operating point of the assembly formed by the electric machine and the inverter. This map has at least the rotational speed of the electric machine or the frequency of the electric current applied thereto as parameter.

In at least part of the map, the chopping frequency is furthermore chosen based on a parameter representative of a thermal condition of the electronic switches contained in the inverter.

By conditioning the choice of the chopping frequency to a parameter representative of the thermal condition of the inverter (in particular of the electronic switches of the inverter), it is especially possible to limit the number of changes in chopping frequency during the use of the electric machine. This limits the disadvantages in terms of NVH of applying a variable chopping frequency strategy, in particular in an application to an electric motor vehicle. Furthermore, a limitation of the number of changes in chopping frequency during the use of the electric machine greatly simplifies the operation of the inverter and of the electric machine, in that numerous operation parameters are less often modified.

The map may furthermore include, as parameter, the torque setpoint to be applied to the electric machine or the current intensity setpoint to be applied to the electric machine by the inverter.

Although the described devices and methods are applicable with a very simple map, namely a map having as its sole parameter the rotational speed of the electric machine or the frequency of the alternating current at the output of the inverter, taking a second parameter into account in the construction of the map makes it possible to further limit the occurrences of a change of chopping frequency, while retaining a variable chopping frequency strategy, especially allowing effective protection of the inverter against overheating and a certain optimization of the power efficiency.

According to one embodiment, the parameter representative of the thermal condition of the switches of the inverter may be a measured temperature of said switches or an estimated temperature of the switches based on the operating parameters of the inverter over time.

According to another embodiment, the parameter representative of the thermal condition of the switches may be a function of the current voltage of a battery for powering the inverter and the electric machine and of a temperature of a coolant present in a coolant circuit of the inverter.

There are thus different means for evaluating the temperature of the inverter switches. A direct measurement can thus be used. But this measurement is not always possible, or not always necessary. It is thus possible to estimate the temperature of the switches, or more generally their thermal condition (it is not necessary to have a precise temperature value in order to implement the described methods and devices) using measurements that are already available or easy to take on the inverter, the electric machine, and/or their peripheral components. Thermal condition is understood to mean especially a temperature, a temperature range, and/or a temporal thermal gradient of the switches of the inverter. Typically, the parameter representative of the thermal condition of the switches of the inverter may be any parameter, or the result of any function, which makes it possible to approximate the current and/or future temperature of the switches of the inverter, with sufficient precision to characterize a risk of overheating, and in this case apply a suitable chopping frequency.

The use of the voltage of the battery that powers the inverter and the electric machine on the one hand, and of the temperature of the coolant of the coolant circuit of the inverter (and where applicable of the electric machine) proves to be particularly advantageous because these are parameters that vary relatively slowly over time. The fact of taking them into account by an appropriate function makes it possible to obtain the protection and the optimization in the use of the inverter which are sought within the described scope, while still further limiting the untimely changes in chopping frequency.

In a nominal operation area of the assembly formed by the electric machine and the inverter, the chopping frequency can be chosen from among three different chopping frequencies, namely a first chopping frequency, a second chopping frequency, and a third chopping frequency. In this case, the map can define three parts in the nominal operation area, namely a first part, a second part and a third part, and
when the current operating point of the assembly formed by the electric machine and the inverter is positioned in said first part, the first chopping frequency is chosen,
when the current operating point of the assembly formed by the electric machine and the inverter is positioned in said second part, the second chopping frequency is chosen or the third chopping frequency is chosen, depending on the parameter representative of the thermal condition of the electronic switches contained in the inverter, and
when the current operating point of the assembly formed by the electric machine and the inverter is positioned in a third part, the third chopping frequency is chosen.

According to one embodiment, the first part of the map may correspond to the part of the nominal operation area positioned up to a first threshold of rotational speed of the electric machine or of frequency of the electric current applied thereto. The second part of the map may correspond to the part of the nominal operation area positioned above the first threshold of rotational speed of the electric machine or of frequency of the electric current applied thereto and above a threshold of intensity setpoint of the current to be applied to the electric machine or of torque setpoint. The third part of the map may correspond to the part of the nominal operation area positioned above the first threshold of rotational speed of the electric machine or of frequency of the electric current applied thereto and which extends up to the threshold of intensity setpoint of the current to be applied to the electric machine or of torque setpoint.

According to another embodiment, the first part of the map may correspond to the part, on the map, of the nominal operation area positioned up to a first threshold of rotational speed of the electric machine or of frequency of the electric current applied thereto. The second part of the map may correspond to the part of the nominal operation area positioned above the first threshold of rotational speed of the electric machine or of frequency of the electric current applied thereto and which extends to a second threshold of rotational speed of the electric machine or of frequency of the electric current applied thereto. The third part of the map may correspond to the part of the nominal operation area positioned above the second threshold of rotational speed of the electric machine or of frequency of the electric current applied thereto.

Advantageously, the first chopping frequency is less than the second chopping frequency, and the second chopping frequency is less than the third chopping frequency.

For example, the first chopping frequency can be comprised between 4 kHz and 6 kHz, for example equal to 5 kHz, the second chopping frequency can be comprised between 6 kHz and 9 kHz, for example equal to 8 kHz; and the third chopping frequency can be comprised between 9 kHz and 12 kHz, for example equal to 10 kHz. The maps thus proposed align with the objectives sought through the use of a variable chopping frequency strategy and with those of the described methods and devices. Thus, the use of a relatively low first frequency in a low motor speed range (which can result in a low frequency of the electrical currents applied to the electric machine) allows better power efficiency and guarantees thermal protection of the inverter in situations of low motor speeds, for example for electric motor vehicles in starting situations, especially under high torque (situation with wheel blocked on starting, driving up onto a sidewalk, etc.).

However, outside this situation of low motor speed, it is possible to adopt a relatively high chopping frequency, better suited to the desired sampling and responsiveness for the electric machine, while guaranteeing the integrity of the inverter.

In one embodiment, when the current operating point of the assembly formed by the electric machine and the inverter is positioned in the second part of the map, the second chopping frequency is chosen if the temperature of the coolant at the inlet of the inverter is above a predefined value positioned between 50° C. and 90° C., for example 70° C., and if the voltage of the battery is greater than a predefined voltage comprised between 300 V and 380 V, for example 340 V, and the third chopping frequency is chosen if these conditions are not met.

The application of the second chopping frequency can thus be conditioned on a simple rule based on the voltage of the battery and on the temperature of the liquid of the inverter coolant circuit, typically measured at the input of the inverter. A more elaborate function of these two parameters can advantageously be used. Especially, above a certain temperature threshold of the coolant (for example 50° C.), the more the temperature of said coolant rises, the more the voltage threshold considered for the application of the second chopping frequency decreases.

When the rotational speed of the electric machine exceeds a maximum rotational speed such that the operating point of the assembly exits the nominal operation area, a fourth chopping frequency is chosen, the fourth chopping frequency being greater than the third chopping frequency. The fourth frequency may for example be comprised between 10 kHz and 15 kHz, for example 13 kHz.

The fourth chopping frequency, provided in particular for overspeed situations of the electric machine, is only used in exceptional situations.

The present description also relates to a method for controlling an inverter controlling a rotating electric machine, said control method including the steps of:
implementing a method for selecting a chopping frequency as described hereinbefore,
applying the chosen chopping frequency to the inverter.

The present description also relates to a device including an inverter and a rotating electric machine controlled by the inverter, the inverter including an electronic control device configured to select a chopping frequency by implementing a method as described hereinbefore, and to apply the selected chopping frequency to the inverter.

The present description finally relates to an electric motor vehicle including such a device.

The field of motor vehicles thus constitutes the preferred field of application. Indeed, in this field, performance levels in terms of NVH are important for the user of a vehicle. Further, since the described devices and methods allow for more accurate sizing of the inverter (since it is not necessary to oversize the power stage of the inverter in order to allow it to be used under exceptionally unfavorable conditions in the operating area where the use of a lower chopping frequency makes it possible to guarantee the integrity thereof), the economic savings and savings in terms of weight, even if they might appear moderate on the scale of a single electric traction chain, are very important on the scale of several thousand (or even millions of) vehicles.

Other features and advantages will become more apparent in the description below.

### BRIEF DESCRIPTION OF THE FIGURES

In the appended drawings, given by way of non-limiting examples:

FIG. 1 depicts a map of the operation of an assembly including an inverter and an electric machine controlled by the inverter, which can be used in a first embodiment.

FIG. 2 depicts a map of the operation of an assembly including an inverter and an electric machine controlled by the inverter, which can be used in a second embodiment.

FIG. 3 is a graphic representation of a function linking the temperature of a coolant present in a coolant circuit of an inverter and the supply voltage of the inverter, which can be used in an embodiment.

### DETAILED DESCRIPTION

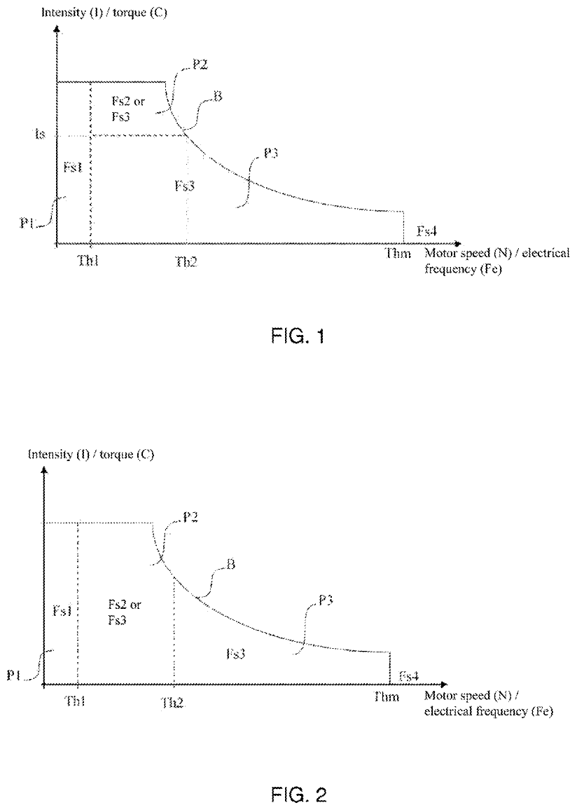

FIG. 1 depicts a map of the operation of an assembly including an inverter and an electric machine controlled by the inverter, which can be used in a first embodiment.

This two-dimensional map includes two parameters, each parameter defining one dimension of the map.

The first parameter taken into account is the rotational speed or motor speed N of the electric machine controlled by the inverter, or the frequency Fe of the electric current applied to the electric machine. Indeed, there is a direct relationship between these two equivalent parameters, namely a bijective relationship for a synchronous electric machine.

The second parameter of the map is the intensity setpoint I of the current to be applied to the electric machine, or the torque setpoint C supplied to the inverter for application thereof to the electric machine. There is also a direct relationship between these two equivalent parameters.

The nominal operation area of the assembly including the inverter and the electric machine is delimited on the map depicted by a border B.

Four chopping frequencies are predefined, namely a first chopping frequency Fs1, a second chopping frequency Fs2, a third chopping frequency Fs3 and a fourth chopping frequency Fs4, such that:

Fs1<Fs2<Fs3<Fs4.

By way of typical examples, the following values can be used, especially in the context of an automotive application: Fs1=5 kHz. Fs2=8 kHz, Fs3=10 kHz and Fs4=13 kHz.

According to the proposed map, the first chopping frequency Fs1 is a low chopping frequency used for the low rotational speeds of the electric machine (or the low-frequency currents applied by the inverter to the electric machine). The first chopping speed is chosen and applied, in the depicted example, in a first part of the map P1, for any rotational speed of the electric machine or any frequency of the current applied to the electric machine less than or equal to a first threshold Th1 (for example 300 revolutions per minute if motor speed is considered as the first parameter).

The first chopping frequency provides a responsiveness and a possibility of sampling that are sufficient for the system in this low motor speed range of the electric machine, while limiting the switching losses of the inverter, which could cause significant heating of the inverter in case of high torque setpoint, which is frequent when starting an electric vehicle.

The third chopping frequency Fs3 is the default chopping frequency of the inverter in question.

The second chopping frequency Fs2 is a reduced frequency with respect to the default chopping frequency Fs3. The objective of the second chopping frequency Fs2 is to allow the use of a high current in the event of use of extreme conditions, without causing overheating of the electronic switches of the inverter. Thus, in the map example of FIG. 1, the third chopping frequency Fs3 is chosen and applied in a third part P3 of the map. The third part P3 extends over a wide range of rotational speeds positioned above the first threshold Th1 and up to the maximum rotational speed Thm (in the nominal operation area). In the example shown, the third part P3 is moreover bounded according to a limit of the second parameter of the map, namely by a threshold of intensity setpoint Is of the current to be applied to the electric machine (or by the corresponding threshold of torque setpoint). The third part P3 is positioned below and up to this threshold of intensity setpoint Is.

The map presented in FIG. 1 finally includes, in the nominal operation area, a second part P2 positioned above the first threshold Th1 of the first parameter of the map, and above the threshold of intensity setpoint Is (or the corresponding threshold of torque setpoint). Due to the boundary B of the nominal operation area, the second part P2 incidentally extends up to a second threshold Th2 of the first parameter of the map (motor speed N or frequency Fe of the current applied to the electric machine). Similarly, it is possible to determine first the second threshold Th2, which incidentally defines the threshold of intensity setpoint Is (or the corresponding threshold of torque setpoint).

In particular, the choice of thresholds (of motor speed or intensity) that define the limit of the second part of the map takes into account the following:
a minimum limit of ratio between the chopping frequency and the electrical frequency, making it possible to ensure satisfactory sampling,
a maximum current value below which no risk of overheating of the inverter is possible even under the most unfavorable operating conditions of the assembly including the inverter and the electric machine.

In this second part P2, the third chopping frequency Fs3, that is to say the default chopping frequency of the inverter, is chosen. However, certain conditions may lead to excessive heating of the inverter. This is why, if certain conditions are met, the second chopping frequency Fs2 is chosen and applied.

These conditions are evaluated using a parameter representative of the thermal condition of the electronic switches contained in the inverter. This parameter may be a direct measurement of the temperature of these switches. This parameter may be an evaluation of this temperature using an adapted estimator, that is to say a function of parameters whose measurement is available in the inverter or the electric machine (especially the intensity, the voltage and the frequency of the electric currents applied to the electric machine controlled by the inverter over time). If the measured or estimated temperature of the electronic switches of the inverter is used, it is however preferable or even necessary to impose hysteresis on this parameter in order to avoid the risk of repeated changes in the chopping frequency when the measured or evaluated temperature is close to a limit condition.

Preferably, it is proposed to use, as a parameter representative of the thermal condition of the electronic switches, a function of the electrical voltage of the battery that powers the inverter and the electric machine and of the temperature of a coolant present in a coolant circuit of the inverter. The coolant circuit may also be shared with a coolant circuit of the electric machine. The temperature of the coolant is preferably (but not necessarily) measured at the inlet of the inverter.

It is then preferable, or even necessary, to impose hysteresis on the electrical voltage of the battery and on the temperature of the coolant to avoid the risk of repeated changes of the frequency when the voltage of the battery is close to limit conditions.

The choice and application of the second chopping frequency Fs2 in the second part P2 of the map therefore depends on these two parameters, considered together. In particular, the second chopping frequency Fs2 is applied when the inverter coolant temperature is high (typically above 50° C. to 70° C. at the input of the inverter) and the voltage of the supply battery is also high (according to the application considered, which is for example an electric motor vehicle, and only by way of non-limiting example, a voltage of more than 340 V can be considered to be high).

The function of the electrical voltage of the battery that powers the inverter and the electric machine and the temperature of a coolant present in a coolant circuit of the inverter used can be based on fixed thresholds of these variable parameters or thresholds.

In particular, with fixed thresholds, the conditions of choice and application of the second chopping frequency can be considered to be met as soon as one of these two parameters exceeds the fixed threshold, or, preferentially, as soon as the two parameters exceed the fixed threshold.

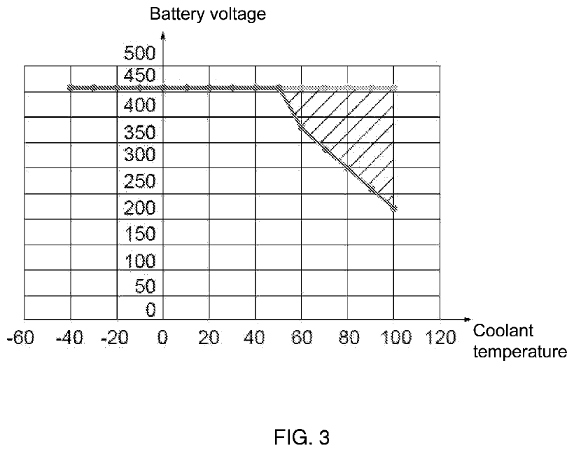

A function using variable thresholds is detailed below referring to FIG. 3.

Finally, the fourth chopping frequency Fs4 is chosen and used for the exceptional cases of overspeed of the electric machine, when its rotational speed exceeds the maximum speed Thm and exits the nominal operation area.

Thus, the choice and application of the second chopping frequency Fs2 may be, in the example detailed hereinbefore, conditioned on three cumulative conditions:
a current setpoint of a minimum intensity, so that it represents a risk of overheating under unfavorable environmental conditions;
a minimum battery voltage (a high voltage increases the losses in the inverter), and
a minimum coolant temperature.

By allowing the choice and application essentially of only two chopping frequencies, namely the first chopping frequency Fs1 and the third chopping frequency Fs3, and by reserving the use of the second chopping frequency Fs2 to the infrequent conditions of use of the inverter likely to cause excessive heating, the described methods and devices thus make it possible to obtain the main advantages of a variable frequency strategy applied to an inverter, while very greatly limiting the occurrences of a change from one chopping frequency to another, which avoids the disadvantages of these changes in terms of NVH.

FIG. 2 depicts a map of the operation of an assembly including an inverter and an electric machine controlled by the inverter, which can be used in a second embodiment. The map of FIG. 2 is similar to that of FIG. 1, with the exception of the definition of the second part P2 and of the third part P3 of the nominal operation area of the map. Except for this aspect, reference may therefore be made to the description of FIG. 1 which is applicable to FIG. 2.

As noted above, the definition of the first part P1 wherein the first chopping frequency Fs1 is applied is unchanged compared to the map of FIG. 1.

The second part P2 on the other hand is defined as being the part of the nominal operation area positioned above the first threshold Th1 of rotational speed of the electric machine or of frequency of the electric current applied thereto and which extends up to a second threshold Th2 of rotational speed of the electric machine or of frequency of the electric current applied thereto.

The third part P3 of the map of FIG. 2 on the other hand corresponds to the part of the nominal operation area positioned above the second threshold Th2. Thus, although FIG. 2 depicts a two-dimensional map (or a map with two parameters) in order to allow its comparison with the map of FIG. 1, the strategy of choosing the chopping speed presented in FIG. 2 is based only on the motor speed of the electric machine or the frequency of the current applied thereto, and does not use the current intensity setpoint or the torque setpoint to determine the chopping frequency to be applied. In other words, the map used in the embodiment of FIG. 2 may be one-dimensional (with a single parameter).

The conditions that determine the application of the third chopping frequency or the second chopping frequency in the second part of the map may be similar to those recited for FIG. 1.

The embodiment of FIG. 2 thus constitutes a simplified embodiment, compared to that of FIG. 1, which may lead to a slightly more frequent application of the second chopping frequency Fs2, but which is very simple to implement.

Of course, some adaptations of the exemplary embodiments presented above are possible without departing from the scope. For example, the first part P1 of the map could be positioned above a minimum current intensity or torque setpoint.

FIG. 3 graphically depicts an example of a function of the temperature of a coolant present in a coolant circuit of an inverter and of the supply voltage of the inverter, which can be used to determine, for example in the part P2 of the map of FIG. 1 or of FIG. 2, if the second chopping frequency Fs2 must be applied or conversely if the default chopping frequency, that is to say the third chopping frequency Fs3, can be maintained.

The graph of FIG. 3 depicts, on the X-axis, the temperature of the coolant of a cooling circuit of an inverter controlling an electric traction machine of a motor vehicle. The voltage of the supply battery of the inverter and of the electric machine is plotted on the Y-axis. This battery has a voltage at full charge of the order of 460 V. This voltage drops gradually as the battery discharges.

According to the function depicted, the conditions that require the application of the second chopping frequency Fs2 are only met when the current (present) voltage of the battery and the temperature of the coolant are in the hatched area of FIG. 3.

Thus, until the coolant temperature of the inverter is less than 50° C., there is no risk of overheating of the inverter, and it is not necessary to choose and apply to the inverter the second chopping frequency. Beyond 50° C., the risks of overheating of the inverter are all the more significant when the voltage of the supply battery is high. Thus, in the example shown, when the temperature of the coolant is 60° C., it is only considered necessary to apply the second chopping frequency Fs2 if the voltage of the battery is greater than approximately 380 V. When the temperature of the coolant is 80° C., it is only considered necessary to apply the second chopping frequency Fs2 if the voltage of the battery is greater than 300 V. The application of such a function based on variable and interdependent thresholds of inverter coolant temperature and battery voltage makes it possible to furthermore limit the occurrence of changes in the chopping frequency of the inverter.

Of course, FIG. 3 corresponds to a particular application, and the values given by way of example may be adapted depending on the application considered.

An example application is thus developed below. In an electric motor vehicle, an inverter having a maximum power of 150 kW with a maximum phase current of 500 A is powered by a battery voltage battery between 300 V and 460 V. The inverter can operate at full power with a coolant between −40° C. and 70° C. and is configured to apply a power limitation when this temperature exceeds 70° C.

For a motor speed comprised between 0 rpm and 300 rpm, the first chopping frequency Fs1=5 kHz is chosen and applied.

Thus, at each start Fs1=5 kHz is applied, without consideration of other parameters.

For a motor speed comprised between 300 rpm and 9000 rpm, the third chopping frequency Fs3=10 kHz, or, if necessary, the second chopping frequency Fs2=8 kHz, is applied according to the choice described hereunder.

For a motor speed comprised between 9000 rpm and 14000 rpm, the third chopping frequency Fs3=10 kHz is applied.

As regards the motor speeds comprised between 300 rpm and 9000 rpm, the choice between Fs2 and Fs3 can be carried out in the following way, in accordance with an embodiment.

By default, the third chopping frequency Fs3 is chosen and applied.

The intensity setpoint of the current to be applied to the machine is monitored. It is in particular observed whether or not the intensity setpoint of the current exceeds Is=340 A RMS (effective current).

Furthermore, the inverter coolant temperature is monitored. The voltage of the supply battery is also monitored. The higher the voltage, the greater the switching losses in the inverter, and the less the inverter (and in particular its power stage) will be able to accept a high current intensity without risk of overheating.

In the present example, for a water inlet temperature of 70° C., the second chopping frequency Fs2=8 kHz is chosen for a battery voltage between 340 V and 460 V.

For any battery voltage less than 340 V, the third chopping frequency is chosen and applied.

The described methods and devices thus developed thus make it possible to obtain the main advantages of a variable frequency strategy applied to an inverter, while very greatly limiting the occurrences of a change from one chopping frequency to another, which avoids the disadvantages of these changes in terms of NVH.

Indeed, the conditional choice of the second chopping frequency proposed allows its application only under severe conditions of use of the inverter, which lead to a risk of overheating. However, this makes it possible to guarantee that the assembly including the inverter and the electric machine can provide, at least temporarily, a high torque without exceeding the maximum admissible temperature for the semiconductors of the inverter, in particular for the electronic switches of the inverter (typically of the IGBT type or the MOSFET type).

The second chopping frequency Fs2, the use of which is limited to a reduced operating area and particular operating conditions of the assembly including the inverter and the electric machine will be very infrequently chosen and applied. The transitions to and from this second chopping frequency Fs2 are thus rare and have little influence on the comfort of the vehicle equipped with this assembly, in terms of noise, vibration and harshness.

Finally, the power module of the inverter can be sized by taking into account that, in the case of exceptional situations, a chopping frequency less than the default chopping frequency will be applied, in order to avoid overheating while guaranteeing operation at full power of the electric machine (without however triggering safety mode). Thus, the electronic power components can be better utilized. Cost and mass gains can be achieved.

1. A method for selecting a chopping frequency for application thereof to an inverter controlling a rotating electric machine,
wherein the chopping frequency is chosen from among multiple predetermined frequencies depending on the position, in a map, of a current operating point of the assembly formed by the electric machine and the inverter, said map having at least the rotational speed (N) of the electric machine or the frequency (Fe) of the electric current applied thereto as parameter,
wherein in at least part of the map, the chopping frequency is furthermore chosen based on a parameter representative of a thermal condition of the electronic switches contained in the inverter,
wherein:
in a nominal operation area of the assembly formed by the electric machine and the inverter, the chopping frequency is chosen from among three different chopping frequencies, namely a first chopping frequency (Fs1), a second chopping frequency (Fs2), and a third chopping frequency (Fs3),
and wherein the map defines three parts in the nominal operation area, namely a first part (P1), a second part (P2) and a third part (P3), and wherein:
when the current operating point of the assembly formed by the electric machine and the inverter is positioned in said first part (P1), the first chopping frequency (Fs1) is chosen,
when the current operating point of the assembly formed by the electric machine and the inverter is positioned in said second part (P2), the second chopping frequency (Fs2) is chosen or the third chopping frequency (Fs3) is chosen, depending on the parameter representative of the thermal condition of the electronic switches contained in the inverter, and
when the current operating point of the assembly formed by the electric machine and the inverter is positioned in a third part, the third chopping frequency (Fs3) is chosen.

2. The method according to claim 1, wherein
the first part (P1) of the map corresponds to the part of the nominal operation area positioned up to a first threshold (Th1) of the rotational speed (N) of the electric machine or of the frequency (Fe) of the electric current applied thereto,
the second part (P2) of the map corresponds to the part of the nominal operation area positioned above the first threshold (Th1) of the rotational speed of the electric machine or of the frequency (Fe) of the electric current applied thereto and which extends up to a second threshold (Th2) of the rotational speed (N) of the electric machine or of the frequency (Fe) of the electric current applied thereto,
the third part (P3) of the map corresponds to the part of the nominal operation area positioned above the second threshold (Th2) of the rotational speed of the electric machine or of the frequency (Fe) of the electric current applied thereto.

3. The method according to claim 1, wherein
the first part (P1) of the map corresponds to the part of the nominal operation area positioned up to a first threshold (Th1) of the rotational speed (N) of the electric machine or of the frequency (Fe) of the electric current applied thereto,
the second part (P2) of the map corresponds to the part of the nominal operation area positioned above the first threshold (Th1) of the rotational speed (N) of the electric machine or of the frequency (Fe) of the electric current applied thereto and above a threshold of an intensity setpoint (Is) of the current to be applied to the electric machine or of a torque setpoint,
the third part (P3) of the map corresponds to the part of the nominal operation area positioned above the first threshold (Th1) of the rotational speed (N) of the electric machine or of the frequency (Fe) of the electric current applied thereto and which extends up to the threshold of the intensity setpoint (Is) of the current to be applied to the electric machine or of the torque setpoint.

4. A method for selecting a chopping frequency for application thereof to an inverter controlling a rotating electric machine,
wherein the chopping frequency is chosen from among multiple predetermined frequencies depending on the position, in a map, of a current operating point of the assembly formed by the electric machine and the inverter, said map having at least the rotational speed (N) of the electric machine or the frequency (Fe) of the electric current applied thereto as parameter,
wherein in at least part of the map, the chopping frequency is furthermore chosen based on a parameter representative of a thermal condition of the electronic switches contained in the inverter,
wherein the map further includes, as parameter, the torque setpoint (C) to be applied to the electric machine or the intensity setpoint (I) of the current to be applied to the electric machine by the inverter.

5. The method according to claim 1, wherein the parameter representative of the thermal condition of the switches of the inverter is a measured temperature of said switches or an estimated temperature of the switches based on the operating parameters of the inverter over time.

6. The method according to claim 1, wherein the parameter representative of the thermal condition of the switches is a function of the current voltage of a battery for powering the inverter and the electric machine and of a temperature of a coolant present in a coolant circuit of the inverter.

7. The method according to claim 6, wherein when the current operating point of the assembly formed by the electric machine and the inverter is positioned in said second part (P2) of the map, wherein the second chopping frequency (Fs2) is chosen if the temperature of the coolant at the inlet of the inverter is above a predefined value positioned between 50° C. and 90° C., and if the voltage of the battery is greater than a predefined voltage comprised between 300 V and 380 V, and the third chopping frequency (Fs3) is chosen if these conditions are not met.

8. The method according to claim 1, wherein the first chopping frequency (Fs1) is less than the second chopping frequency (Fs2), and the second chopping frequency (Fs2) is less than the third chopping frequency (Fs3).

9. The method according to claim 8, wherein:
the first chopping frequency (Fs1) is comprised between 4 kHz and 6 kHz;
the second chopping frequency (Fs2) is comprised between 6 kHz and 9 kHz;
the third chopping frequency (Fs3) is comprised between 9 kHz and 12 kHz.

10. The method according to claim 1, wherein when the rotational speed (N) of the electric machine exceeds a maximum rotational speed (Thm) such that the operating point of the assembly exits the nominal operation area, a fourth chopping frequency (Fs4) is chosen, the fourth chopping frequency (Fs4) being greater than the third chopping frequency.

11. A method for controlling an inverter controlling a rotating electric machine, said control method including the steps of:
implementing a method for selecting a chopping frequency according to claim 1,
applying the chosen chopping frequency to the inverter.

12. A device including an inverter and a rotating electric machine controlled by the inverter, the inverter including an electronic control device configured to select a chopping frequency by implementing a method according to claim 1, and to apply the selected chopping frequency to the inverter.

13. An electric motor vehicle including a device according to claim 12.
